(19) United States
(12) Patent Application Publication
(10) Pub. No.: US 2008/0048545 A1
(43) Pub. Date: Feb. 28, 2008

(54) Gas-Filled Discharge Gap

(76) Inventors: Juergen Boy, Berlin (DE); Wolfgang Daeumer, Berlin (DE); Frank Werner, Berlin (DE)

Correspondence Address: SLATER & MATSIL, L.L.P., 17950 PRESTON RD, SUITE 1000, DALLAS, TX, 75252-5793, US

(21) Appl. No.: 11/859,586

(22) Filed: Sep. 21, 2007

Related U.S. Application Data
(63) Continuation of application No. PCT/DE2006/000347, filed on Feb. 24, 2006.
(60) Provisional application No. 60/974,320, filed on Sep. 21, 2007.

(30) Foreign Application Priority Data
Mar. 23, 2005 (DE) 10 2005 013 499.8

(51) Int. Cl. H01J 63/04

(52) U.S. Cl. 313/484

(57) ABSTRACT

A gas-filled discharge gap includes at least two electrodes and an electrode-activation mass that is arranged on at least one of the electrodes. The electrode-activation mass contains K₂WO₄.

This application is a continuation of co-pending International Application No. PCT/DE2006/00347, filed Feb. 24, 2006, which designated the United States and was not published in English, and which is based on German Application No. 10 2005 013 499.8 filed Mar. 23, 2005. This application also claims priority to U.S. Provisional Application No. 60/974,320, filed Sep. 21, 2007. Each of these applications is incorporated herein by reference.

### TECHNICAL FIELD

The invention pertains to a gas-filled discharge gap such as a spark gap or an overvoltage arrestor.

### BACKGROUND

A gas-filled discharge gap is known from German patent application DE 198 14 631 A1 and corresponding U.S. Pat. No. 6,326,724. In this case, a vitreous-type electrode-activation mass is used that comprises a plurality of components, including, among others, a base component in the form of cesium tungstate (Cs₂WO₄).

Another gas-filled discharge gap is known from German patent application DE 197 01 816 A1 and corresponding U.S. Pat. No. 5,995,355.

### SUMMARY

Embodiments of the invention disclose a gas-filled discharge gap with adequate quenching properties.

### DETAILED DESCRIPTION OF ILLUSTRATIVE EMBODIMENTS

Embodiments of the invention disclose a gas-filled discharge gap with at least two electrodes, wherein an electrode-activation mass containing potassium tungstate (K₂WO₄) is applied to at least one of the electrodes in order to ensure ignition properties. Potassium tungstate has the properties of a getter material. This material is chemically very stable and can also exert a gettering effect following a surge current. An additional property consists of the generation of free potassium and/or potassium oxide due to the reduction of the K₂WO₄ in the gas-filled cavity, resulting in a low work function of the activation mass.

Potassium tungstate melts at a soldering temperature of approximately 820°, whereby, specifically, loose activation particles are bound so as to prevent the escape of loose activation particles from the activation mass.

The inventive utilization of an activation mass containing potassium tungstate or one of the other potassium compounds ensures very good quenching properties of the overvoltage arrestor gap downstream of an electric load. An overvoltage arrestor with an activation mass containing K₂WO₄ automatically and reliably quenches after a discharge process despite an applied DC voltage.

According to a first preferred embodiment, a discharge gap in the form of a spark gap is disclosed that features, for example, a ceramic hollow body of preferably cylindrical shape with a surface area. The open end surfaces of the hollow body are closed by end electrodes. This results in a closed cavity that is filled with a noble gas.

The activation mass is arranged on the active surfaces of the opposing electrodes. The active surfaces may feature at least one or more depressions in the form of a waffle-like structure for accommodating the activation mass. The term “waffle-like structure” should be interpreted to mean in the form of intersecting depressions. Alternately, the active surface of an electrode may feature several depressions that do not intersect.

According to a second preferred embodiment, a discharge gap in the form of a two-gap overvoltage arrestor is disclosed that features two end electrodes that are preferably arranged on the end surfaces of the hollow body, and a hollow-cylindrical center electrode. A hollow-cylindrical ceramic insulator preferably is respectively arranged between the center electrode and one of the end electrodes.

The activation mass is suitable for being applied to the center electrode as well as on the end electrodes of the overvoltage arrestor. The center electrode may be provided with a peripheral groove for accommodating the activation mass.

In both embodiments, the activation mass may be arranged on the end electrodes on the opposing active electrode surfaces, i.e., in the depressions provided for this purpose.

The activation mass may include a base component, e.g., K₂WO₄.

The activation mass may contain several components, particularly base components. In one advantageous variant, K₂WO₄ is provided as one base component of the activation mass, e.g., in a quantity between approximately 20 and 90 wt %, preferably in a quantity between 30 and 60 wt %.

In one embodiment, the activation mass may contain at least one base component and other additives. Here, one of the base components is K₂WO₄.

Other base components to be considered specifically include
1) metal oxides, e.g., TiO₂;
2) metallic components, e.g., Al and metallic Ti; and
3) halides, e.g., KBr and NaBr.

The activation mass may furthermore contain a glass fraction or silicates, e.g., sodium silicate, cesium silicate and potassium silicate. BaTiO₃, TiO₂, LiNbO₃, Na₂B₄O₇ and MgO may also be considered. Na₂B₄O₇ and MgO are particularly suitable as additives.

The base components may be respectively provided in a quantity of approximately 10 to 90 wt %, and the additives may be respectively provided in a quantity of less than approximately 10 wt %.

According to another embodiment, K₂WO₄ may be provided as an additive, e.g., in a quantity between 1 and 20 wt %, preferably in a quantity between 5 and 10 wt %.

What is claimed is:

1 A gas-filled discharge gap comprising:
at least two electrodes; and
an electrode-activation mass arranged on at least one of the electrodes, wherein the electrode-activation mass contains K₂WO₄.

2. The discharge gap according to claim 1, wherein the discharge gap is realized in the form of a spark gap with two end electrodes arranged on end surfaces.

3. The discharge gap according to claim 1, wherein the discharge gap is realized in the form of an overvoltage arrestor with two end electrodes arranged on end surfaces.

4. The discharge gap according to claim 1, wherein the electrode-activation mass is arranged in a depression of the at least one of the electrodes.
